(19) United States
(12) Patent Application Publication
(10) Pub. No.: US 2017/0265410 A1
(43) Pub. Date: Sep. 21, 2017

(54) VERTICALLY ARRANGED NUTRIENT FILM HYDROPONIC DEVICE

(71) Applicant: Shue-Cheng LIN, Taichung City (TW)

(72) Inventor: Shue-Cheng LIN, Taichung City (TW)

(21) Appl. No.: 15/071,388

(22) Filed: Mar. 16, 2016

(51) Int. Cl. A01G 31/06; A01G 27/00; A01G 31/02

(52) U.S. Cl. CPC A01G 31/06; A01G 31/02; A01G 27/008

(57) ABSTRACT

A nutrient hydroponic device has a pot body, a bottom plate, and a water dripping member. The pot body has an inner space, a water retaining recess, a water dripping hole, and multiple plant holes. The inner space has an opening and a bottom surface. The water retaining recess is annular and is defined in the bottom surface of the inner space. The water dripping hole is defined through the bottom surface of the inner space. The plant holes are defined through the side wall of the pot body. The bottom plate is securely attached to the bottom of the pot body. The water dripping member is mounted through the water dripping hole and the bottom plate and has a shank, a head, and a through hole. The through hole is axially defined through the shank and the head.

### BACKGROUND OF THE INVENTION

1. Field of the Invention

The present invention relates to a hydroponic device, and more particularly to a vertically arranged nutrient film hydroponic device.

2. Description of Related Art

With reference to FIG. 5, a conventional nutrient hydroponic device substantially comprises a stand 50, a tubular body 52, and a water recycling device 54. The tubular body 52 is mounted on and supported by the stand 50 and is inclined relative to the ground to define an upper end and a lower end. Multiple plants, such as vegetables, are grown on the tubular body 52. The water recycling device 54 is connected to the upper end and the lower end of the tubular body 52 to form a water recycling loop. Accordingly, water is fed to the tubular body 52 from the upper end and can flow to the lower end with the gravity. The redundant water may be led to the upper end by the water recycling device 54 to irrigate the plants on the tubular body 52.

However, the conventional nutrient hydroponic device occupies a large space for arranging the inclined tubular body 52. Therefore, to arrange multiple conventional hydroponic devices requires a lot of space, so the conventional nutrient hydroponic device is inconvenient in use.

To overcome the shortcomings, the present invention tends to provide a nutrient hydroponic device to mitigate or obviate the aforementioned problems.

### SUMMARY OF THE INVENTION

The main objective of the invention is to provide a nutrient hydroponic device that can be stacked vertically and is convenient in use.

The nutrient hydroponic device has a pot body, a bottom plate, and a water dripping member. The pot body has a top, a bottom, a side wall, an inner space, a water retaining recess, a water dripping hole, and multiple plant holes. The inner space is defined in the pot body and has an opening defined in the top of the pot body and a bottom surface. The water retaining recess is annular and is defined in the bottom surface of the inner space. The water dripping hole is defined through the bottom surface of the inner space. The plant holes are defined through the side wall of the pot body. The bottom plate is securely attached to the bottom of the pot body. The water dripping member is mounted through the water dripping hole in the pot body and the bottom plate and has a shank, a head, and a through hole. The shank is mounted through the water dripping hole in the pot body and the bottom plate. The head is formed on an end of the shank and is held in the inner space of the pot body. The through hole is axially defined through the shank and the head.

Other objects, advantages and novel features of the invention will become more apparent from the following detailed description when taken in conjunction with the accompanying drawings.

### BRIEF DESCRIPTION OF THE DRAWINGS

FIG. 1 is a perspective view of a nutrient hydroponic device in accordance with the present invention;

FIG. 2 is an exploded perspective view of the nutrient hydroponic device in FIG. 1;

FIG. 3 is an operational side view in partial section of the nutrient hydroponic device in FIG. 1;

FIG. 4 is an operational side view in partial section showing multiple nutrient hydroponic devices in FIG. 1 stacked vertically with each other; and

FIG. 5 is a side view of a conventional nutrient hydroponic device.

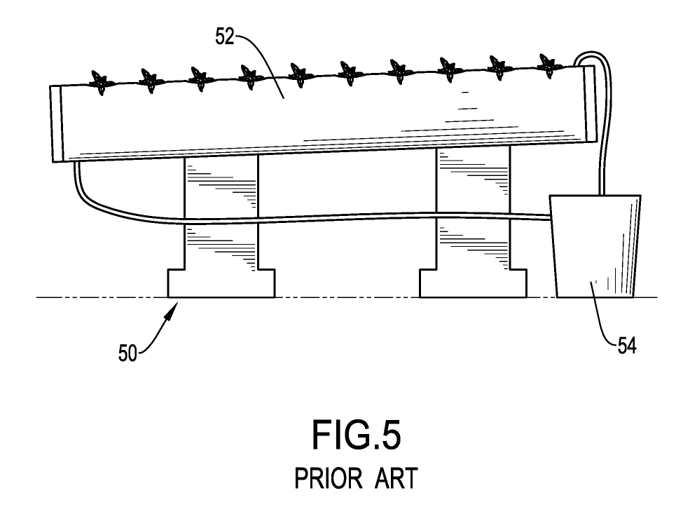

### DETAILED DESCRIPTION OF PREFERRED EMBODIMENT

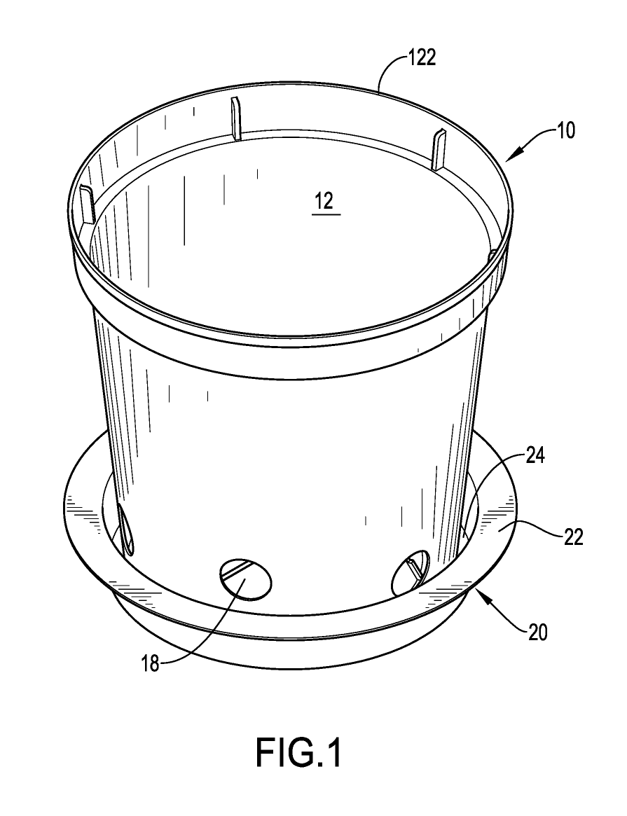

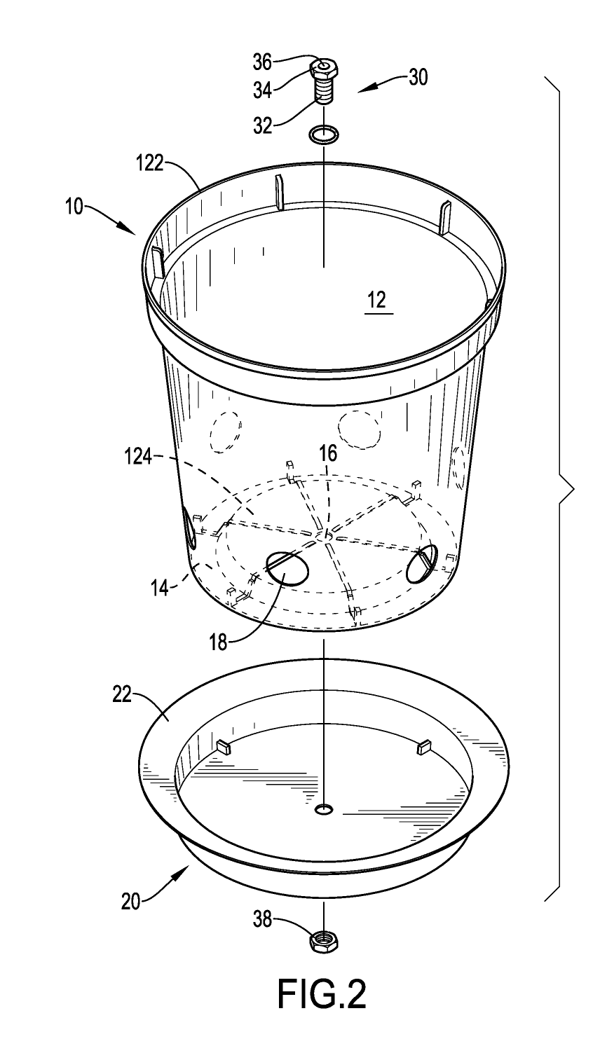

With reference to FIGS. 1 to 3, a nutrient hydroponic device in accordance with the present invention comprises a pot body 10, a bottom plate 20 and a water dripping member 30.

The pot body 10 may be conical and has a side wall, an inner space 12, a water retaining recess 14, a water dripping hole 16 and multiple plant holes 18. The inner space 12 is defined in the pot body 10 and has an opening 122 defined in a top of the pot body 10 and a bottom surface 124. The water retaining recess 14 is annular and is defined in the bottom surface 124 of the inner space 12. The water dripping hole 16 is defined through the bottom surface 124 of the inner space 12. Preferably the water dripping hole 16 is defined through a center of the bottom surface 124 of the inner space 12. The plant holes 18 are defined through the side wall of the pot body 10 at positions adjacent to the annular water retaining recess 14.

The bottom plate 20 is securely attached to a bottom of the pot body 10 and has an abutting flange 22 and a diameter. The abutting flange 22 is formed on and protrudes radially from a top of the bottom plate 20. The diameter of the bottom plate 20 is larger than a diameter of the pot body 10 to define an annular space 24 between the pot body 10 and the bottom plate 20.

The water dripping member 30 is mounted through the water dripping hole 16 in the pot body 10 and the bottom plate 20 and comprises a shank 32, a head 34, and a through hole 36. The shank 32 is mounted through the water dripping hole 16 in the pot body 10 and the bottom plate 20 and may be threaded to screw with a nut 38 to securely connect the pot body 10 with the bottom plate 20 by the water dripping member 30. The head 34 is formed on an end of the shank 32 and is held in the inner space 12 of the pot body 10. The through hole 36 is axially defined through the shank 32 and the head 34.

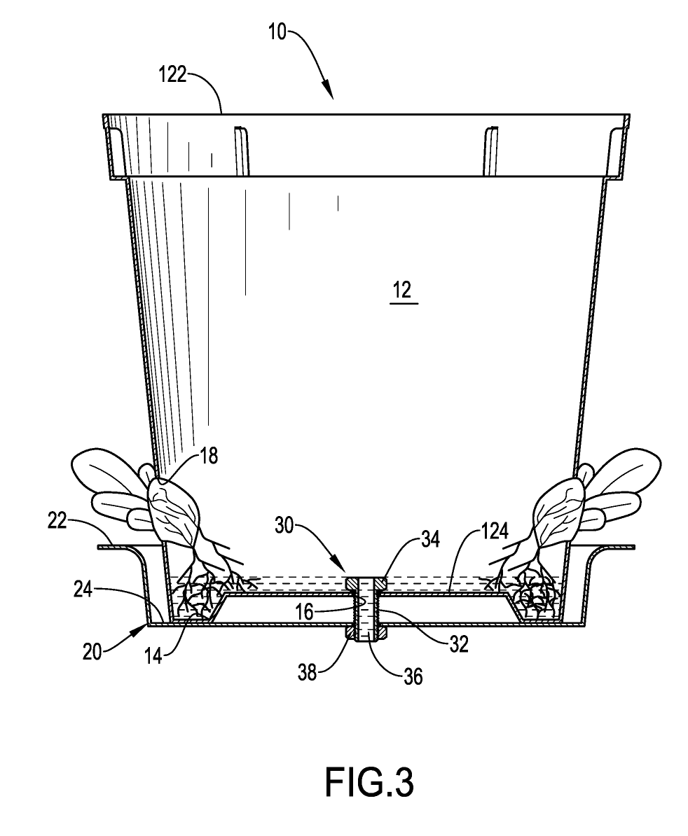

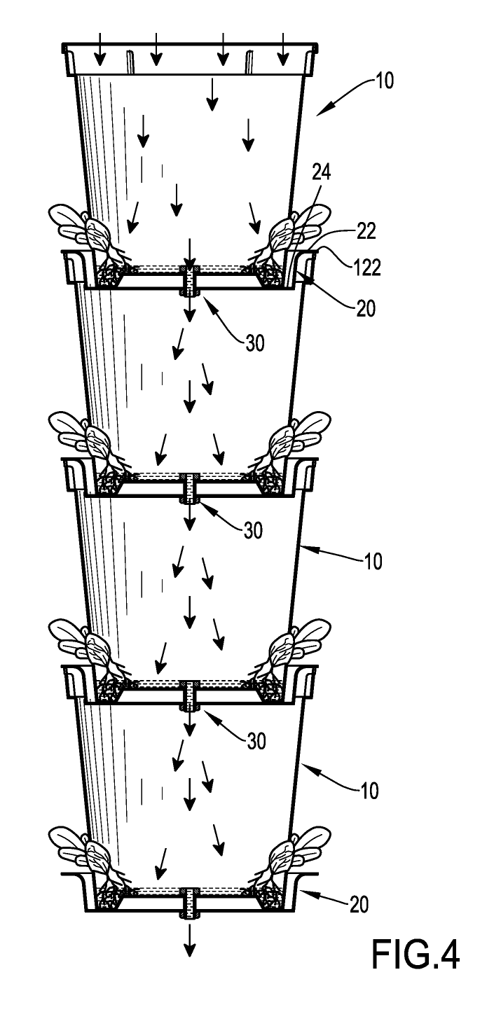

In use, with reference to FIGS. 3 and 4, nutrient plants, such as vegetables are planted in the pot body 10 to enable the roots of the plants to extend into the water retaining recess 14 and the leaves of the plants to extend out of the plant holes 18 in the pot body 10. Multiple hydroponic devices can be stacked with each other. The bottom plate 20 of an upper one of the hydroponic devices is mounted into the opening 122 of the pot body 10 of a lower one of the hydroponic devices. The abutting flange 22 of the bottom plate 20 of an upper one of the hydroponic devices abuts the top of the pot body 10 of a lower one of the hydroponic devices. Accordingly, multiple hydroponic devices can be vertically stacked with each other. To implant the plants in the pot bodies 10, water is poured into the pot body 10 from the opening 122 of the pot body 10 of the uppermost hydroponic device. The water will be held in the water retaining recess 14 in the pot body 10 of the uppermost hydroponic device. When the water level in the inner space 12 is higher than the top end of the water dripping member 30 in the pot body 10 of the uppermost hydroponic device, the redundant water will flow into the pot body 10 of the next one of the hydroponic devices via the through hole 36 in the water dripping member 30 and is held in the water retaining recess 14 in the pot body 10 of the next hydroponic device. Consequently, the water will flow into the pot bodies 10 of the vertically stacked hydroponic devices in sequence via the through holes 36 of the water dripping members 30. Accordingly, the water can be supplied to the plants to enable the plants to grow. Because multiple hydroponic devices in accordance with the present invention can be stacked vertically with each other, the space for arranging multiple hydroponic devices can be minimized, and the use of the hydroponic device is convenient.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A nutrient hydroponic device comprising:
a pot body having
a top;
a bottom;
a side wall;
an inner space defined in the pot body and having an opening defined in the top of the pot body and a bottom surface;
a water retaining recess being annular and defined in the bottom surface of the inner space;
a water dripping hole defined through the bottom surface of the inner space;
multiple plant holes defined through the side wall of the pot body;
a bottom plate securely attached to the bottom of the pot body; and
a water dripping member mounted through the water dripping hole in the pot body and the bottom plate and comprising
a shank mounted through the water dripping hole in the pot body and the bottom plate;
a head formed on an end of the shank and held in the inner space of the pot body; and
a through hole axially defined through the shank and the head.

2. The nutrient hydroponic device as claimed in claim 1, wherein the pot body is conical.

3. The nutrient hydroponic device as claimed in claim 2, wherein the water dripping hole is defined through a center of the bottom surface of the inner space.

4. The nutrient hydroponic device as claimed in claim 3, wherein the plant holes are defined in the side wall of the pot body at positions adjacent to the annular water retaining recess.

5. The nutrient hydroponic device as claimed in claim 4, wherein the bottom plate has an abutting flange formed on and protruding radially from a top of the bottom plate.

6. The nutrient hydroponic device as claimed in claim 5, wherein the bottom plate has a diameter larger than a diameter of the pot body to define an annular space between the pot body and the bottom plate.

7. The nutrient hydroponic device as claimed in claim 6, wherein the shank of the water dripping member is threaded and is screwed with a nut to securely connect the pot body with the bottom plate by the water dripping member.

8. The nutrient hydroponic device as claimed in claim 1, wherein the water dripping hole is defined through a center of the bottom surface of the inner space.

9. The nutrient hydroponic device as claimed in claim 1, wherein the plant holes are defined in the side wall of the pot body at positions adjacent to the annular water retaining recess.

10. The nutrient hydroponic device as claimed in claim 1, wherein the bottom plate has an abutting flange formed on and protruding radially from a top of the bottom plate.

11. The nutrient hydroponic device as claimed in claim 1, wherein the bottom plate has a diameter larger than a diameter of the pot body to define an annular space between the pot body and the bottom plate.

12. The nutrient hydroponic device as claimed in claim 1, wherein the shank of the water dripping member is threaded and is screwed with a nut to securely connect the pot body with the bottom plate by the water dripping member.
